(19) United States
(12) Patent Application Publication
(10) Pub. No.: US 2004/0090960 A1
(43) Pub. Date: May 13, 2004

(54) Data transmission

(76) Inventors: Maunu Holma, Helsinki (FI); Sami Kekki, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/416,008

(22) PCT Filed: Nov. 5, 2001
(86) PCT No.: PCT/IB01/02744

(30) Foreign Application Priority Data
Nov. 6, 2000 (GB) 0027071.0

(51) Int. Cl. H04L 12/28; H04L 12/56

(52) U.S. Cl. 370/392; 370/412

(57) ABSTRACT

A sub data packet (37₀₋₃) for transferring data between a first and second node comprising a payload (38) of data comprising a portion of the data from an original data packet (30) and a header (39) including an end-of-packet flag (41) which can be set to indicate if the payload of data in said sub data packet comprises the data segment from the end of the original data packet (30) and a priority identifier (40) located in the header indicating a transmission priority of the original data packet.

The present invention relates to point-to-point transmission of data. In particular, but not exclusively, the invention relates to the transmission of data packets between first and second nodes in a telecommunication network.

As is known in the art analogue cellular systems such as the public switched telephone network (PSTN) are referred to as first generation telecommunication systems. Digital systems such as the global system for mobile communication (GSM) have been developed and are classed as second generation systems. Third generation (3G) systems are now being designed which can support multi-media communications. The standards for this 3G system are being specified by the third generation partnership project (3GPP). Also e.g., 3GPP2 and IETF are today involved in this standardisation work. These 3G mobile communication systems are often referred to as UMTS (Universal Mobile Telecommunication Systems).

Compared to GSM and other existing networks, the UMTS will provide the added feature of allowing variation of the properties of a radio bearer. That is the properties defining how data may be transferred over a wireless connection. Such characteristics of the transfer may include the definition of delay and error rates. In addition UMTS has been designed to support applications which have different duality of service (QoS) requirements. The present invention has as one aim the purpose of specifying a solution for supporting Qos in telecommunication networks (for example in an internet protocol (IP) network). Particularly, the invention will be useful in those parts of a network which are effectively narrowband. In these, link capacities, that is the data capacity of links between two nodes or points of the network for example a sender and receiver node, can for example be limited to 1 to 5 Mbit/s.

Discussion of QoS issues in a narrowband transmission environment have until now been mainly concentrated on the issue of bandwidth efficiency in terms of overhead caused by any solution (the amount of overhead information per actual payload information). In this discussion the delay to date has been considered from the point of view of how much multiplexing can be done into a common unit of data transport (such as, in the case of the universal terrestrial radio access network (UTRAN), and IP data packet) Another problem which has been appreciated is the delay which can be caused by small link rates in the system. Due to those small bit rates of the link it takes a longer time to transmit a data packet of a certain size through the interface. The fact that it takes a longer time to transmit N octets through the interface when the interface bit rate is smaller, comes from the formula: Time to transmit=Amount of bits in the frame (bits)/the bit rate of the interface (bits/s)=>bits/(bits/s)=s.

One suggested answer to this question is simply to restrict the size of the data packet transmitted (common transmission units). However, there are cases where the restriction of the packet size may not be sufficient or it may not be available as an option to guarantee an adequate quality of transmission.

One such case is signalling transport. Certain application protocols (AP), such as a Node-B AP (NBAP) in 3G UTRAN may generate such large messages that sending the messages may occupy the narrowband transmission link for too long a period of time. This would cause a degradation to user plane traffic sharing the same physical link.

Another case where this problem might occur is in non real time (NRT) packet transport. IP packets generated by an NRT application may be too big for special transmission such as low bit rate cellular access even though these IP packets would be considered small in terms of IP transport in general.

It is an aim of the present invention to at least partly mitigate the above-referenced problems.

The present invention also has an aim to provide a mechanism which enables data to be transferred from one point to another point without causing undue degradation to data transfer. Another

Another aim is to provide a mechanism which offers improved ability for the narrowband transmission environment such as for example point-to-point El/Tl transmission for cellular access in the case of small capacity based stations.

According to one aspect of the present invention there is provided a sub data packet for transferring data between a first and second node comprising:

a payload of data comprising a portion of the data from an original data packet; and

a header including an end-of-packet flag which can be set to indicate if the payload of data in said sub data packet comprises the data segment from the end of the original data packet and a priority identifier located in the header indicating a transmission priority of the original data packet.

According to a second aspect of the present invention there is provided a method of segmenting an original data packet into a plurality of sub data packets comprising the steps of:

dividing said original data packet into a plurality of sub data packets each including a respective portion of said original data packet;

providing a priority identifier in each sub data packet which identifies a transmission priority of the original data packet;

providing an end-of-packet flag in a header portion of each sub data packet; and

setting the flag in the sub data packet in which the payload data comprises the data from the end of the original data packet.

According to a third aspect of the present invention there is provided a method of transmitting data comprising a plurality of original data packets from a first node to a second node of a telecommunication system comprising the steps of:

at the first node, segmenting the original data packets according to the method of claim 10;

transmitting the sub data packets from the first node to the second node; and reconstructing the original data packets from the received sub-data packets.

According to a fourth aspect of the present invention there is provided apparatus for a use at a first node of a telecommunications network comprising:

data packet receiving means for receiving original data packets;

segmenting means for segmenting each of said original data packets into a plurality of sub data packets each of said sub data packets including:

a payload of data comprising a portion of the data from an associated original data packet; and

a header including a priority indicator and an end-of-packet flag.

For a better understanding of the present invention reference will now be made by way of example only, to the accompanying drawings, in which:—

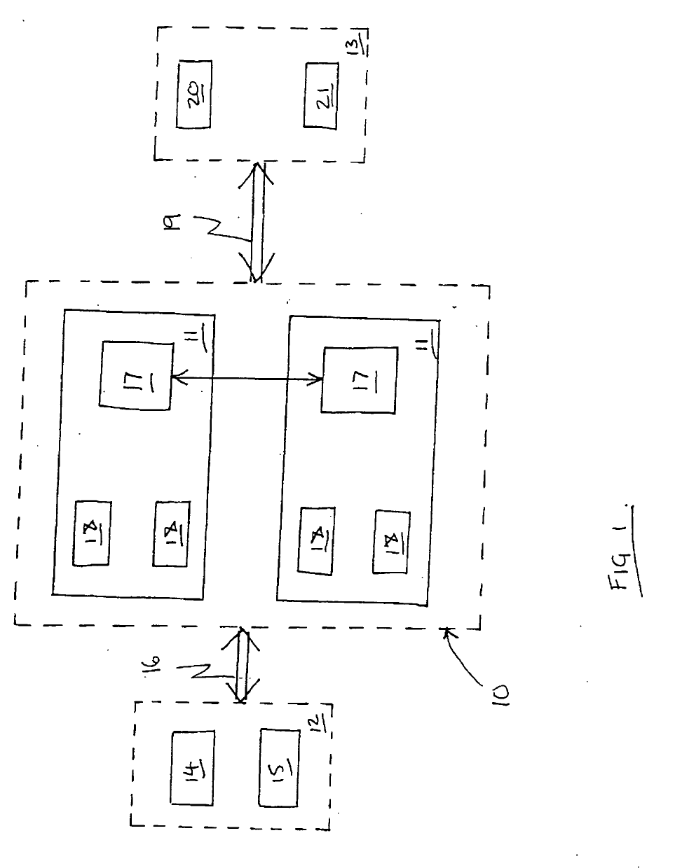

FIG. 1 illustrates UTRAN architecture, and

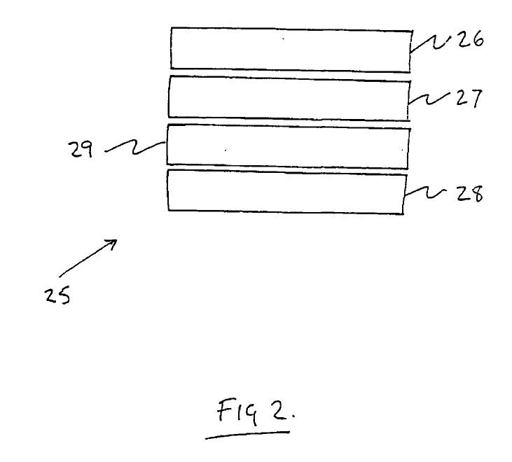

FIG. 2 illustrates a protocol stack.

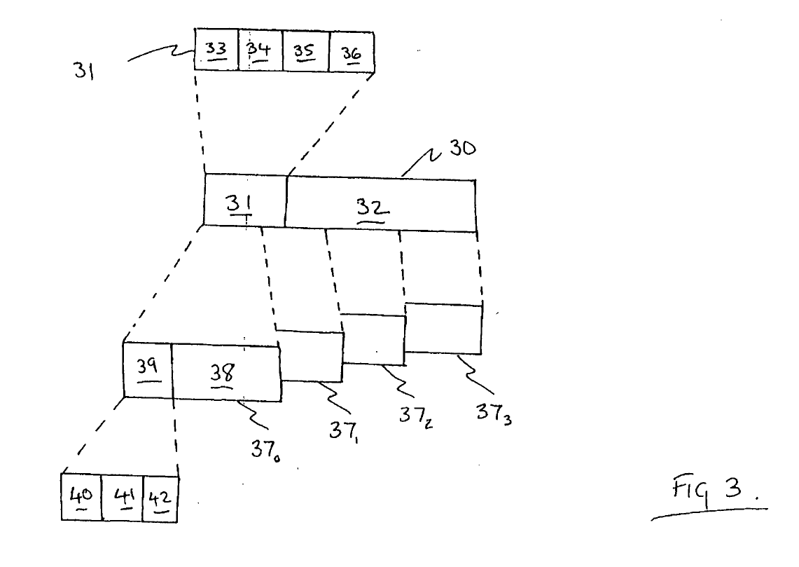

FIG. 3 illustrates the segmentation of an original data packet.

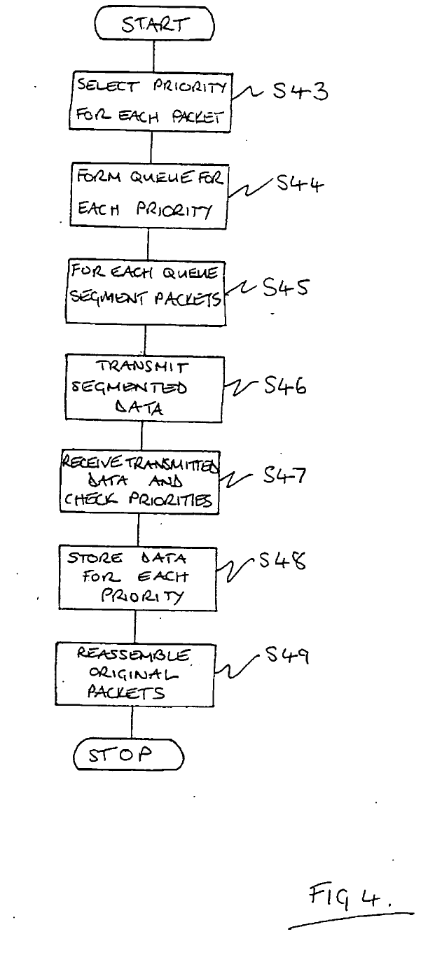

FIG. 4 illustrates the segmentation procedure.

In the drawings like reference numerals refer to like parts.

FIG. 1 shows how the general layout of a universal terrestrial radio access network (UTRAN) 10 including one or more radio network sub systems (RNS) 11 are connectable to user equipment (UE) 12 and core network (CN) 13.

The UE can include mobile equipment (ME) 14 which can comprise a mobile station (MS) and a UMTS subscriber identifier module (USIM) 15, such as a smart card which holds subscriber identity information. The UE and UTRAN communicate with each other over the Uu interface 16. This is a wireless radio interface.

Radio network controllers (RNC) 17 in an RNS 11 control radio resources and control management of connections over the Uu interface 16 with Node-B 18. Node-B (which is analogous to a GSM base station) converts and manages dataflow over the Uu interface.

The RNC's 17 communicate with the CN 13 over the Iu interface 19 (this is analogous to the A-interface in GSM for circuit switched applications and Cb-interface in GSM for packet switched applications). The CN 13 can include the mobile services switching centre (MSC) and a visitor location register (VLR) 20 together with a gateway MSC 21 via which the UMTS public land mobile network (PLMN) can be connected to other core service (CS) networks.

In considering data traffic over the radio access interface 16 it is convenient to consider the network protocol stack 25 of FIG. 2. The protocol stack (or protocol suite) illustrates the layered manner in which the protocols which enable various devices to communicate with one another are set out in a telecommunication system. In developing networking protocols in layers, each layer can be made responsible for different aspects of the communication. The protocol stack illustrates the combination of different protocols at different layers.

FIG. 2 shows the lowest four layers of the protocol stack. Above these would come the transport layer (not shown) indicating the flow of data between two points and the application layer (not shown) which handles the details of a articular application. The top layer 26 shown in FIG. 2 is the network layer, for example the IP layer. This layer of protocol handles movement of packets around a network. In particular the routing of packets is handled at this level. Below this level is the link level 27. This is effectively an interface layer to the network which allows an application to connect to and communicate with the network. This layer typically handles the interfacing with the physical layer 28 which itself refers to the media being used for transferring data i.e. wireless connection or cable.

An example of the link level layer 27 is the point-to-point protocol (PPP) which describes a way to segment or encapsulate IP data packets ( ). IP data packets are often called datagrams because of the fact that the packet itself contains all the information the network (layer) needs to route it through any network (it contains the data and the global address), however big it might be. I.e., the packet is a self-contained unit of data in this respect (like the datagram in the posting business). The PPP divides the datagram into at least a first portion including the payload of the original IP data gram together with a header, a second link control portion including link control data generated by the PPP (which can be used to test the data link connection) and a header and a third network control data portion with header generated by the PPP. An example of a physical layer protocol is point-to-point fractional E1/T1 transmission which can be utilised for cellular access in the case of small capacity base stations.

Between the link layer 27 and the physical layer 28 is the transmission segmentation layer 29 which can be considered part of the (Data) Link layer. The segmentation layer 29 is particularly useful for any narrowband physical layer in the cases where the Data Link layer is expected to generate long or variable length frames.—Although it will be appreciated that its use is not so restricted.

The protocol of the segmentation layer is responsible for segmenting relatively large datagrams received from the link layer into a number of smaller/shorter sub data frames which can then be transmitted over the physical layer without the disadvantages associated with large data packets. In this way at least one positive effect which is achieved is the reduction of delay in other data links being transmitted over the same transmission media. This is because the transmission link does not have to be active for only one channel/user for a period of time which is overly long. In the instance of RT voice communication this means that other users of the channel will not have their transmission deactivated for any period of time which will be noticeable.

FIG. 3 helps illustrate how original data packets 30 which represent a data packet (or datagram) which is of such a size that its transmission “over the wire” cause an inadequate quality of transmission are structured. The original data packet includes an original header 31 and an original payload 32. These are made up of a successive series of data units or bits which can be combined as octets. Octets are bytes in this case.

The contents of the original header 31 are shown exploded so that their contents can be more clearly identified. The original header can include a path and channel identifier portion 33.

These bits provide information to identify a path along which the data should pass and the channel connection which should be used for transmission. The original header 31 may also include a payload type identifier 34. These bits identify the type of information carried by the original data packet. Priority bits 35 may also be included which can indicate on a scale how important the data is and/or whether the data packet should be discarded if congestion is encountered. Error check bits 36 can also be included, for example an 8-bit cyclical redundancy check (CRC), to protect the integrity of the data.

The payload 32 includes data units or bits arranged in octets which are used to transmit data. In the sense that the data is (normally) arranged in an octet-aligned structure. That is the packets as well as the frames contain an integer number of octets instead of just an arbitrary number of bits. When designing a telecommunication system the system designer selects for each link the number of transmission priorities of IP packets in each link. The transmission priority for each IP packet then needs to be selected from within these possible priority ratings.

Prior to transmission the original data packet is segmented into sub data packets 370-3 as can be seen more clearly in FIG. 3. As shown the original data packet is divided into four equally sized sub data packets. It will be understood that any number could be used. Each sub data packet 37 includes a sub-payload 38 and sub-header 39. The sub-payload 38 includes data from the corresponding portion of the original data packet. In addition, a sub-header is added. Each sub-header 39 includes a transmission priority identifier 40, and “end-of-frame” flag 41, and cycling identifier 42. It will be understood that Packets are the units of the network layer. Like IP packets. The nickname of an IP packet is this datagram because of the earlier mentioned reason). The Link layer however generates and processes data frames, like PPP frames. Whether frame or packet is used depends on the user of the segmentation layer. If there is some link layer above the segmentation layer then it generates frames that the segmentation layer segments into sub-frames. However, if the segmentation layer is used directly below the IP layer (which is possible), then we might say that the “IP packets are segmented into segmentation frames”. The term “packet” will be understood to be broad enough to cover both the described frames or packets.

The transmission priority identifier 40 indicates the priority of the original data packet and may comprise two bits which can thus indicate one of four possible transmission priorities. These priority bits can indicate the QoS stipulated for the original data.

The end-of-packet flag 41 may comprise one bit which is set only in the last sub data packet 373. The bit indicates that the segment is the last segment of the segmented frame/packet. in the sub-payload 38 of which is stored the data from the end of the original data packet 30.

The cycling identifier 42 may comprise five bits to allow for up to 32 different identifiers. Subpackets that serve the same original packet have the same cycling identifier. The cycling identifier changes when a new original packet starts. In this way, the receiving side can notice that a new original packet has started, even if the subpacket carrying the end-of-packet flag had been lost. There is no restriction on the amount of subpackets per original packet.

In this way there can be segments originating from different original frames/packets in any order in the wire and the receiver needs to check the cycling id to determine which segment is part of which original frame/packet. In fact in embodiments of the invention the priority bit and the end-of-packet flag are enough to reassemble the original packet from the flow of segments, if no segments are lost or corrupted. The cycling identifier can thus provide a second check so that if a segment is lost the bad effect is restricted to that packet.

FIG. 4 illustrates the order of events for transferring data according to an embodiment of the present invention. At step S43 each of the original data packets which are to be transmitted are provided with a priority rating. For each priority rating a queue of original data packets is formed at step S44. Next for each priority queue, starting with the head of queue data packet, that is the first data packet in that queue, the original data packets are segmented at step S45. Typically this will be done by segmenting the original data packets in the highest priority queue first. Step S45 includes dividing the header 31 and payload 32 of each original data packet 30 into portions, each of which is stored in the sub-payload 38 of a respective sub data packet 37. A sub-header 39 is formed for each sub data packet which includes priority bits indicating the priority of the original data packet, an end-of-flag bit for indicating if the sub data packet includes the end portion of the original data packet and a cycling identifier. The sub data packets can then be transmitted at step S46 in the order of their transmission priority. Since the sub data packets each contain a reduced amount of data compared to the original data packet they can be transmitted over a link without causing any intolerable delay. This is dependent to some extent upon the link rate of the connection media. Table 1 shows the service times for different service rates and packet sizes in more detail.

TABLE 1
Service times for different service rates and packet sizes.

| | Service | Service | Service | Service | Service |
|---|---|---|---|---|---|
| | time with | time with | time with | time with | time with |
| Size of | Service | service | service | service | service |
| packet/ | rate 4 * 64 | rate 1 | rate 5 | rate 155 | rate 622 |
| octets | kbit/s/ms | Mbit/s/ms | Mbit/s/ms | Mbit/s/ms | Mbit/s/ms |
| 100 | 3.125 | 0.8 | 0.16 | 0.00516 | 0.000129 |
| 1000 | 31.25 | 8 | 1.6 | 0.516 | 0.00129 |
| 10000 | N/a | 80 | 16 | 0.516 | 0.0129 |
| 64000 | N/a | 512 | 102 | 3.30 | 0.823 |

For example when the link rate is 1 Mbit/s an NRT packet of 1000 octets would delay the RT traffic as much as 8 ms in the worst case. This may well be intolerable for many cases. For example in Utran lub there is a very tight delay budget and all the available delay in that budget is used up by multiplexing the RT channels together. Additional delays of this magnitude caused by NRT traffic cannot be tolerated.

Once the data has been received at step S47 the priorities of the transmitted sub data packets can be checked and then the data can be stored in separate stores for each priority rating S45. This involves storing the transmission cell payloads 37₀₋₃ for each sub data packet sharing the particular priority rating.

After this the original data packet can be reassembled at step S49 using the end-of-packet flag and the cycling identifier to identify where an original packet ends and another starts. So the end-of-packet flag identifies the last segment of the packet while the cycling identifier identifies the frames belonging to the same original packet. Note that as we are talking about a link layer protocol (or a protocol being a part of the link layer, we can assume that the sequence of segments is maintained on the link. That is, the last segment of a segmented packet/frame is received last (unless the segment is lost . . . ) If the recipient notes that the cycling identifier has changed so as to indicate another original data packet is being sent before the sub data packet having the end-of-packet flag indicator set has been received, the recipient can ascertain that an error has occurred during transmission and the IP data packet can be discarded.

Once a data packet has been successfully received and reconstructed it can be forwarded.

In a further embodiment two transmission priorities (named e.g. as “RT” and “NRT”) can be used whilst the maximum length of transmission cell (sub data packet) can be set, for example, at 50 octets. This allows use of “RT” for voice communication and for real-time data traffic (real-time either by definition or because of macro-diversity), and “NRT” for non-real-time data traffic. In this sense Macro-diversity approximately means that in 3GRAN, connections can have several branches controlled (and combined) by the RNC. The purpose of the branches is to provide soft handover when the mobile user moves from one cell to another, even if the cells are controlled by different RNC.)

Soft Hand-over refers to the case where a Mobile Station is attached to more than one radio cell, so that it is transmitting and receiving the same transmission via these radio cells. The radio cells can physically be located in different Node Bs. The branches refer to these separate connections between the Mobile Station (UE) and the Serving Radio Network Controller (S-RNC) conveying the same data. In the context of this invention the branches are between the Node Bs (where the radio cells reside) and the S-RNC. As the data received from these different branches is combined in the endpoint (i.e., in the S-RNC) by selecting the best parts of data from the different branches, the process is called Macro-diversity Combining. “Macro” refers to the fact that the branches are only combined in the RNC and the “diversity” refers to the different characteristics of these branches (though the same data is conveyed by all).

In summary there are features which need to indicate in the header, and then there are advantageous features which are needed to make the system reliable and fast to recover from errors.

The receiver can have simultaneously as many packets under reassembly as there are priorities. The receiver must be able to:

a) see to which priority a segment belongs to;

b) detect if the segment ends the packet, so that the receiver can send the packet further.

In order to provide the receiver with the necessary information, embodiments indicate the following things in the header of each segment:

a) the priority to which the segment belongs;

b) if the segment is the last segment of the packet.

In order to improve the reliability, embodiments can provide that the receiver can recover fast from lost segments or corrupted segment headers. One way (although not the only way) to help this is to include a “cycling id” in the header. The cycling id has two options:

a) Be equal for segments of the same original data.

b) Start from zero when a packet starts, and increment per each segment.

In alternative a), the receiver can detect that a new packet has started, when the cycling id changes. In alternative b), the receiver can detect that a new packet has started, when the cycling id starts again from zero. The cycling id could be for instance 32 bits long, although this is not the only possible choice. Note that the cycling id is not the only way to improve the reliability of the system.

Preferably the invention will not be used for transmission of data over routed interfaces nor for cases where a high band width is available.

It will be understood that the present invention is not limited by the specific examples herein described rather there are several variations and modifications which may be made to the disclosed solution without departing from the scope of the present invention as defined in the appended claims.

Embodiments may be implemented independently of the type of the used transport protocol and at any desired node. It should also be appreciated that whilst embodiments of the present invention have been described in relation to wireless user equipment embodiments of the present invention are applicable to any other suitable type of user equipment.

Embodiments of the present invention have been described in the context of wireless telecommunications network.

Embodiments of the present invention can be used in any network, wireless or otherwise where a plurality of flows of data units pass through a node with a limited capacity.

1. A sub data packet for transferring data between a first and second node comprising:
a payload of data comprising a portion of the data from an original data packet; and
a header including an end-of-packet flag which can be set to indicate if the payload of data in said sub data packet comprises the data segment from the end of the original data packet and a priority identifier located in the header indicating a transmission priority of the original data packet.

2. The sub data packet of claim 1 wherein the end-of-data flag comprises at least one bit.

3. The sub data packet of any preceding claim further comprising a cycling identifier which can be set to identify the original data packet.

4. The sub data packet of any preceding claim wherein:
said payload of data comprises a segment of the original data packet.

5. The sub data packet as claimed in claim 4 wherein the sub data packet is formed in a segmentation layer of a telecommunication network.

6. The sub data packet of any preceding claim wherein the payload of data comprising a plurality of successive bits from the original data packet.

7. The sub data packet of any preceding claim wherein the overall size of the sub data packet is equal to or less than 64,000 octets.

8. The sub data packet of any of claims 1 to 7 wherein the overall size of the sub data packet is less than 50 octets.

9. The sub data packet of any preceding claim wherein the first and second nodes are nodes of a telecommunication network.

10. A method of segmenting an original data packet into a plurality of sub data packets comprising the steps of:
dividing said original data packet into a plurality of sub data packets each including a respective portion of said original data packet;
providing a priority identifier in each sub data packet which identifies a transmission priority of the original data packet;
providing an end-of-packet flag in a header portion of each sub data packet; and
setting the flag in the sub data packet in which the payload data comprises the data from the end of the original data packet.

11. The method as claimed in claim 10 further comprising:
setting the end of data flag by setting at least one bit in said sub data packet to a predetermined value.

12. The method of any one of claims 10 to 11 further comprising the steps of:
setting each of a plurality of bits in a header portion of the sub data packets to a predetermined value to thereby provide the cycling identifier.

13. The method as claimed in claims 10 to 12 further comprising:
providing each sub data packet with a cycling identifier identifying the original data packet.

14. The method as claimed in claim 12 further comprising the steps of:
providing the order identifier for each subdata packet in a cyclic order by incrementing the bits of said plurality of bits to thereby identify the original data packet.

15. The method as claimed in any one of claims 10 to 14 wherein the original data packet is segmented in a segmentation layer of a telecommunication network.

16. A method of transmitting data comprising a plurality of original data packets from a first node to a second node of a telecommunication system comprising the steps of:
at the first node, segmenting the original data packets according to the method of claim 10;
transmitting the sub data packets from the first node to the second node; and
reconstructing the original data packets from the received sub-data packets.

17. The method as claimed in claim 16 further comprising the steps of reconstructing the original data packets at the second node.

18. The method as claimed in claim 16 or claim 17 further comprising the steps of:
at the first node identifying a transmission priority of each original data packet; and
segmenting the original data packets in an order according to their transmission priority.

19. The method as claimed in claims 16 to 18 further comprising the steps of:
comparing the cycling identifier of each sub-data packet with an end-of-packet flag and responsive thereto identifying a sub data packet to be discarded.

20. The method as claimed in any one of claims 16 to 19 wherein the steps of segmenting the original data packets and reconstructing the original data packets are carried out in the same layer of a telecommunication network.

21. The method as claimed in 20 wherein said same layer comprises a segmentation layer between a link layer and physical layer of the telecommunication network.

22. Apparatus for a use at a first node of a telecommunications network comprising:
data packet receiving means for receiving original data packets;
segmenting means for segmenting each of said original data packets into a plurality of sub data packets each of said sub data packets including:
a payload of data comprising a portion of the data from an associated original data packet; and
a header including a priority indicator and an end-of-packet flag.

23. Apparatus of claim 32 further comprising a cycling identifier.
